(19) United States
(12) Patent Application Publication
(10) Pub. No.: US 2006/0270938 A1
(43) Pub. Date: Nov. 30, 2006

(54) Ultrasound diagnostic apparatus and ultrasound diagnostic method

(75) Inventor: Tsutomu Yawata, Tokyo (JP)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: GE Medical Systems Global Technology Company, LLC

(21) Appl. No.: 11/439,456

(22) Filed: May 23, 2006

(30) Foreign Application Priority Data
May 31, 2005 (JP) 2005-158631

(51) Int. Cl. G06K 9/00

(52) U.S. Cl. 600/509; 382/181

(57) ABSTRACT

By automating the procedure of operation in measuring, the user is enabled to measure each object of measuring without being forced to give an instruction or do setting for each object of measuring, thereby operability is improved. There are provided a setting accepting unit which accepts setting of the number of fetuses in the same mother's body; an item display processing unit which processes displaying of the next measurement item regarding each fetus of the set number of fetuses sequentially according to the fetus and the measurement item to be measured; a generating unit which, every time a measurement item is displayed, generates an ultrasonic image matching the measurement item on the basis of a reflected wave obtained from an ultrasonic probe; an image display processing unit which processes displaying of an ultrasonic diagnostic image; and a measured value acquiring unit which acquires the measured value of the fetus regarding the measurement item displayed by the item display processing unit.

### CROSS REFERENCE TO RELATED APPLICATIONS

This application claims the benefit of Japanese Application No. 2005-158631 filed May 31, 2005.

### BACKGROUND OF THE INVENTION

The present invention relates to an ultrasound diagnostic apparatus and an ultrasound diagnostic method, and further to a technique by which the subject is measured according to a set number.

In conventional practice, when measuring is to be done for each measurement item regarding a fetus with an ultrasound diagnostic apparatus, an ultrasonic probe is pressed against the mother's womb to generate an ultrasonic diagnostic image; as the site of the fetus is displayed in the ultrasonic diagnostic image so generated, the displayed site is measured, and a measurement is acquired for each measurement item.

And if multiple fetuses are present in the same mother's body, the number of fetuses is set on the ultrasound diagnostic apparatus and, after identifiers (e.g. “fetus A” and “fetus B”) are assigned to distinguish each fetus from another, the physician would input a designated identifier to specify the fetus to be measured before measuring is done.

On the other hand, since the measurement items are not altered every time a fetus is measure and, obviously, the number of fetus does not change every time measuring is done, consecutive setting by the physician on every occasion of measuring is troublesome and takes an extra time to do the measuring. There is a further problem that the extended measuring time imposes a heavier burden on the mother's body.

Also, for use in multi-fetus cases, techniques of allocating the values of each measurement item to different identified fetuses are proposed (e.g. Patent Document 1). As such a technique enables values of each measurement item to be allocated to different identified fetuses, the physician's trouble of setting the identity of each fetus is reduced.

[Patent Document 1] JP-A No. 2001-120544

However, since the allocation is automatic according to the technique described in Patent Document 1, where measurements are close to each other, it is conceivable for measurements to be allocated to wrong fetuses. In this case, the physician has to make the change manually, resulting in an even more troublesome setting procedure. Furthermore, as the technique described in Patent Document 1 requires the physician himself, when a different fetus is to be measured, to instruct execution of measuring, the measuring procedure is not automatically set, but there still is a need to give an instruction regarding every fetus, entailing a problem of more complexity in the operational procedure.

### SUMMARY OF THE INVENTION

Therefore, an object of the present invention is to provide an ultrasound diagnostic apparatus, an ultrasound diagnostic method and an ultrasound diagnostic program which makes possible measuring of each object of measuring without forcing the user to do setting for each object of measuring by automating the operational procedure to be followed in measuring.

In order to achieve the object state above, a first aspect of the invention is characterized in that it is equipped with a setting accepting means which accepts setting of the number of fetuses indicating the number of fetuses in the same mother's body; an item display processing means which, regarding each of the fetuses of the number of fetuses set by the setting accepting means, processes sequential displaying of the measurement item to be measured next according to the fetuses and the measurement item which needs to be measured; a generating means which receives a reflected wave from an ultrasonic wave transmitted from an ultrasonic probe every time the measurement item is displayed by the item display processing means, and generates an ultrasonic diagnostic image matching the measurement item according to the reflected wave; an image display processing means which processes displaying of the ultrasonic diagnostic image generated by the generating means; and a measured value acquiring means which, according to the ultrasonic diagnostic image displayed by the image display processing means, acquires the measured value of the fetus with respect to the measurement item displayed by the item display processing means.

According to the first aspect of the invention, as the measurement item to be measured is processed for sequential displaying according to the fetus and the measurement item which needs to be measured, and a measured value is acquired for each displayed measurement item, the procedure of operation in measuring is automated, and the user is enabled to measure each object of measuring without being forced to give an instruction or do setting for each fetus regarding each measurement item, resulting in an effect of improving the operational ease.

A second aspect of the invention is characterized in that, in the first aspect of the invention, the item display processing means repeatedly performs sequential displaying of the measurement items which need to be measured for one of the fetuses as many times as the number of fetuses set by the setting accepting means.

According to the second aspect of the invention, as sequential displaying of the measurement items to be measured for one fetus and the collection of measured values matching measurement items are repeated as many times as the number of fetuses in the first aspect of the invention, when the user demands measuring of each fetus for each measurement item, he/she can sequentially acquire a measured value for each measurement item for each of the number of fetuses without being forced to give an instruction or do setting, and accordingly measuring of each fetus regarding each measurement item is made possible, resulting in an effect of improving the operational ease.

A third aspect of the invention is characterized in that, in the first aspect of the invention, the item display processing means repeats processing of sequential displaying of one kind of the measurement item for each fetus of the number of fetuses set by the setting accepting means as many times as the number of the measurement items which need to be measured.

According to the third aspect of the invention, as acquisition of measured values matching measurement items by sequential displaying of one kind of the measurement item for each fetus of the number of fetuses is repeated as many times as the number of the measurement items which need to be measured, when the user demands measuring according to measurement items for each fetus, he/she can sequentially acquire a measured value for each fetus without being forced to give an instruction or do setting for each fetus, and accordingly measuring of each fetus regarding each measurement item is made possible, resulting in an effect of improving the operational ease.

A fourth aspect of the invention is characterized in that, in any of the first through third aspects of the invention, there is further provided a saving means which saves measured values regarding the measurement items for each of the fetuses measured by the measured value acquiring means.

According to the fourth aspect of the invention, comparison with already saved measured values regarding measurement items for each of fetuses is made possible by saving measured values regarding the measurement items for each of the measured fetuses, and it provides an effect of making it possible to keep track of the growth process of each one of multiple fetuses.

A fifth aspect of the invention is characterized in that, in any of the first through fourth aspects of the invention, the setting accepting means further accepts selection by the user of the measurement item to be measured of the fetus.

According to the fifth aspect of the invention, as it enables the user as required to alter measurement items from fetus to fetus by accepting selection of the measurement item, there is an effect of enhancing the convenience.

A sixth aspect of the invention is characterized in that it is equipped with a setting accepting means which accepts setting of the number of subjects which are to be the objects of measuring; an item display processing means which, regarding each subject of the number of subjects set by the setting accepting means, processes sequential displaying of the measurement item to be measured next according to the subject and the measurement item which needs to be measured; a generating means which receives a reflected wave from an ultrasonic wave transmitted from an ultrasonic probe every time the measurement item is displayed by the item display processing means, and generates an ultrasonic diagnostic image matching the measurement item according to the reflected wave; an image display processing means which processes displaying of the ultrasonic diagnostic image generated by the generating means; and a measured value acquiring means which, according to the ultrasonic diagnostic image displayed by the image display processing means, acquires the measured value of the subject with respect to the measurement item displayed by the item display processing means.

According to the sixth aspect of the invention, as the measurement item to be measured is processed for sequential displaying according to the subject and the measurement item which needs to be measured, and a measured value is acquired for each displayed measurement item, the procedure of operation in measuring is automated, and the user is enabled to measure each subject regarding each measurement item without being forced to give an instruction or do setting for each subject, resulting in an effect of improving the operational ease.

A seventh aspect of the invention is characterized in that it is provided with a setting accepting step at which setting of the number of fetuses indicating the number of fetuses in the same mother's body is accepted; an item display processing step at which, regarding each of the fetuses of the number of fetuses set at the setting accepting step, sequential displaying of the measurement item to be measured next is processed according to the fetuses and the measurement item which needs to be measured; a generating step at which a reflected wave is received from an ultrasonic wave transmitted from an ultrasonic probe every time the measurement item is displayed at the item display processing step, and an ultrasonic diagnostic image matching the measurement item is generated according to the reflected wave; an image display processing step at which displaying of the ultrasonic diagnostic image generated at the generating step is processed; and a measured value acquiring step at which, according to the ultrasonic diagnostic image displayed at the image display processing step, the measured value of the fetus with respect to the measurement item displayed by the item display processing step is acquired.

According to the seventh aspect of the invention, as the measurement item to be measured is processed for sequential displaying according to the fetus and the measurement item which needs to be measured, and a measured value is acquired for each displayed measurement item, the procedure of operation in measuring is automated, and the user is enabled to measure each object of measuring without being forced to give an instruction or do setting for each fetus regarding each measurement item, resulting in an effect of improving the operational ease.

An eighth aspect of the invention is characterized in that, in the seventh aspect of the invention, at the item display processing step sequential displaying of the measurement items which need to be measured is repeatedly performed for one of the fetuses as many times as the number of fetuses set at the setting accepting step.

According to the eighth aspect of the invention, as acquisition of measured values matching measurement items by sequential displaying of one kind of the measurement item for each fetus of the number of fetuses is repeated as many times as the number of the measurement items which need to be measured, it is made possible to sequentially acquire a measured value for each fetus, and accordingly measuring of each fetus regarding each measurement item is made possible, resulting in an effect of improving the operational ease.

An ninth aspect of the invention is characterized in that, in the seventh aspect of the invention, at the item display processing step processing of sequential displaying of one kind of the measurement item for each of the fetuses of the number of fetuses set at the setting accepting step is repeated as many times as the number of the measurement items which need to be measured.

According to the ninth aspect of the invention, as acquisition of measured values matching measurement items by sequential displaying of one kind of the measurement item for each fetus of the number of fetuses is repeated as many times as the number of the measurement items which need to be measured, when the user demands measuring according to measurement items for each fetus, he/she can sequentially acquire a measured value for each fetus without being forced to give an instruction or do setting for each fetus, and accordingly measuring of each fetus regarding each measurement item is made possible, resulting in an effect of improving the operational ease.

A 10th aspect of the invention is in that, in any of the seventh through ninth aspects of the invention, it is further provided with a saving step at which measured values regarding said measurement items are saved for each of said fetuses measured at said measured value acquiring step.

According to the 10th aspect of the invention, comparison with already saved measured values regarding measurement items for each of fetuses is made possible by saving measured values regarding the measurement items for each of the measured fetuses, and it provides an effect of making it possible to keep track of the growth process of each one of multiple fetuses.

An 11th aspect of the invention is characterized in that in any of the seventh through 10th aspects of the invention, at the setting accepting step selection by the user of the measurement item to be measured of the fetus is further accepted.

According to the 11th aspect of the invention, as it enables the user as required to alter measurement items from fetus to fetus by accepting selection of the measurement item, there is an effect of enhancing the convenience.

A 12th aspect of the invention is characterized in that characterized in that a computer is caused to execute the ultrasound diagnostic method according to any of the seventh through 11th aspects of the invention.

According to the 12th aspect of the invention, the ultrasound diagnostic method according to any of the seventh through 11th aspects of the invention can be realized by the use of a computer, and accordingly provides an effect similar to any of these seventh through 11th aspects of the invention.

The ultrasound diagnostic apparatus, the ultrasound diagnostic method and the ultrasound diagnostic program according to the present invention provide the effects of automating the procedure of operation in measuring, enabling the user to measure each item of each fetus or each subject without forcing him/her to give an instruction or do setting for each fetus or subject as they process displaying of measurement items to be measured sequentially according to the fetus or the subject and the measurement item which needs measuring, and acquiring a measured value for each measurement item.

The ultrasound diagnostic apparatus, the ultrasound diagnostic method and the ultrasound diagnostic program according to the present invention are useful for repetition of measuring as many times as a set number, and are especially suitable for techniques of measuring, where multiple fetuses are involved, measuring each measurement item of each fetus.

Further objects and advantages of the present invention will be apparent from the following description of the preferred embodiments of the invention as illustrated in the accompanying drawings.

### BRIEF DESCRIPTION OF THE INVENTION

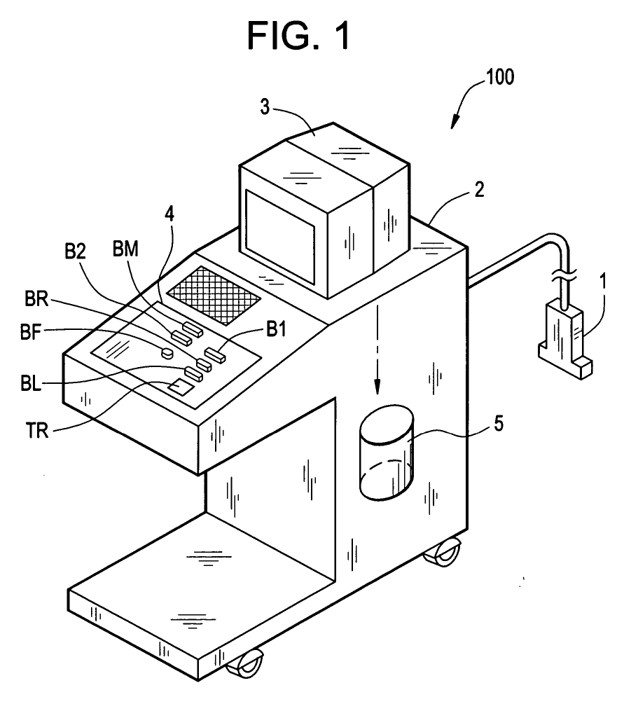

FIG. 1 is a perspective view schematically showing an ultrasound diagnostic apparatus in this mode for implementing the present invention.

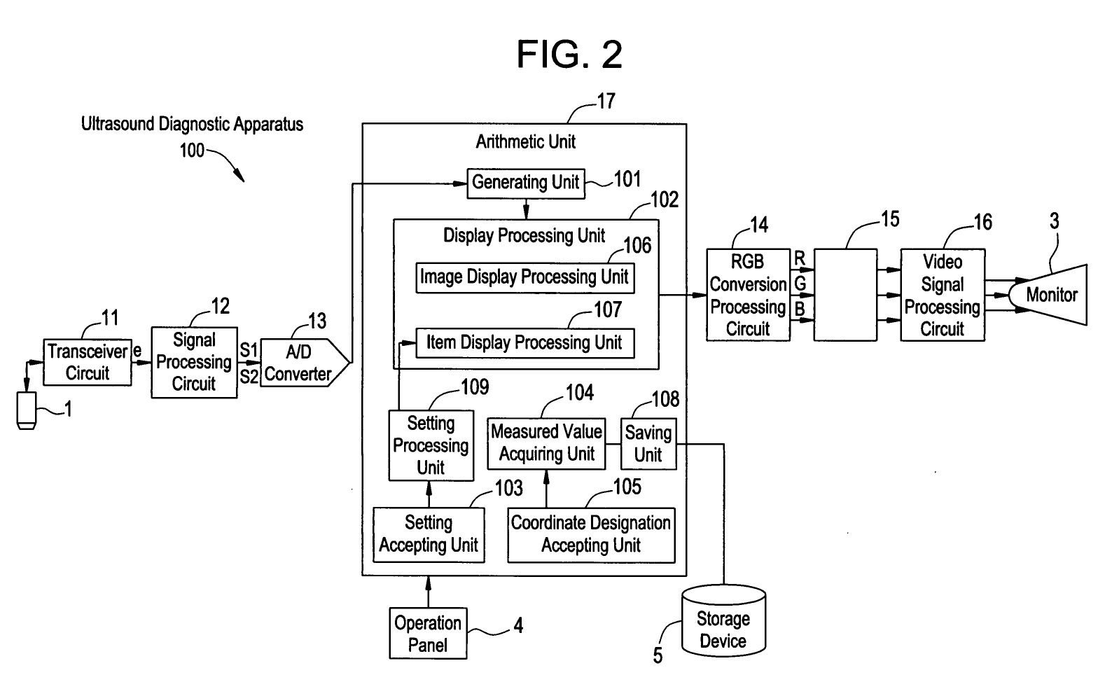

FIG. 2 is a diagram showing the hardware configuration of each unit and functional block built into the ultrasound diagnostic apparatus in the mode for implementing the invention.

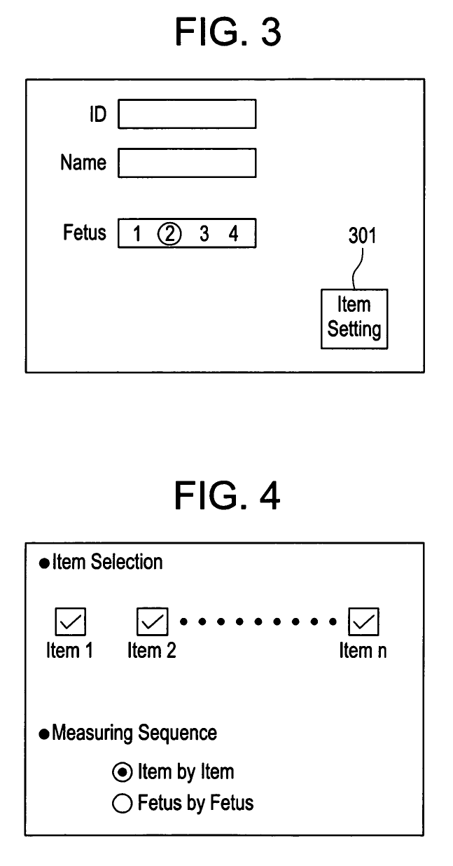

FIG. 3 is a diagram showing an example of measurement object setting screen to be displayed on a monitor before measuring fetuses in the ultrasound diagnostic apparatus in the mode for implementing the invention.

FIG. 4 is a diagram showing an example of setting change screen of items displayed when the “item setting” button has been pressed down in the ultrasound diagnostic apparatus in the mode for implementing the invention.

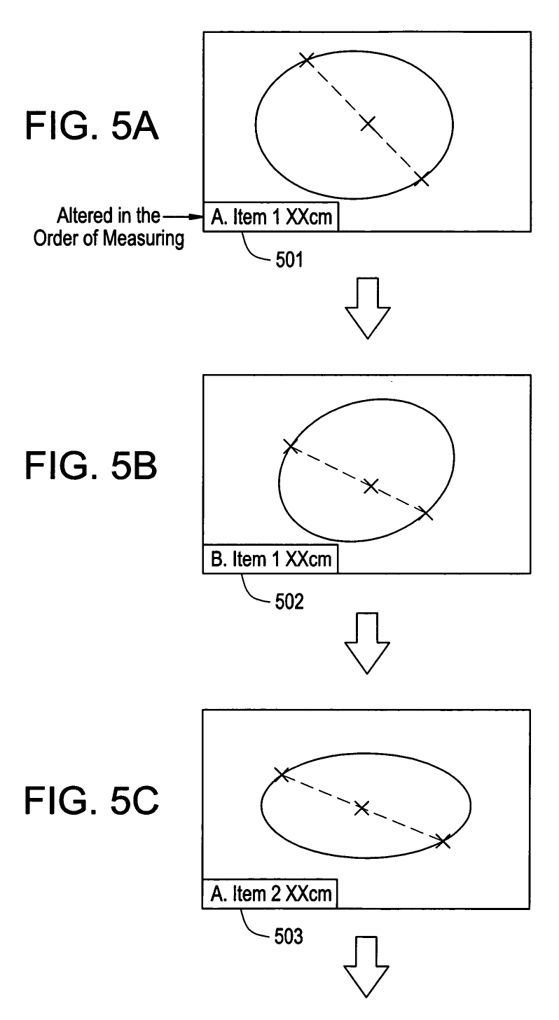

FIGS. 5a, 5b, and 5c are explanatory diagrams showing the sequence from the acceptance of designation of coordinate information from the ultrasonic image displayed for each measurement item of each fetus until the displaying of the measured value in the ultrasound diagnostic apparatus in the mode for implementing the invention.

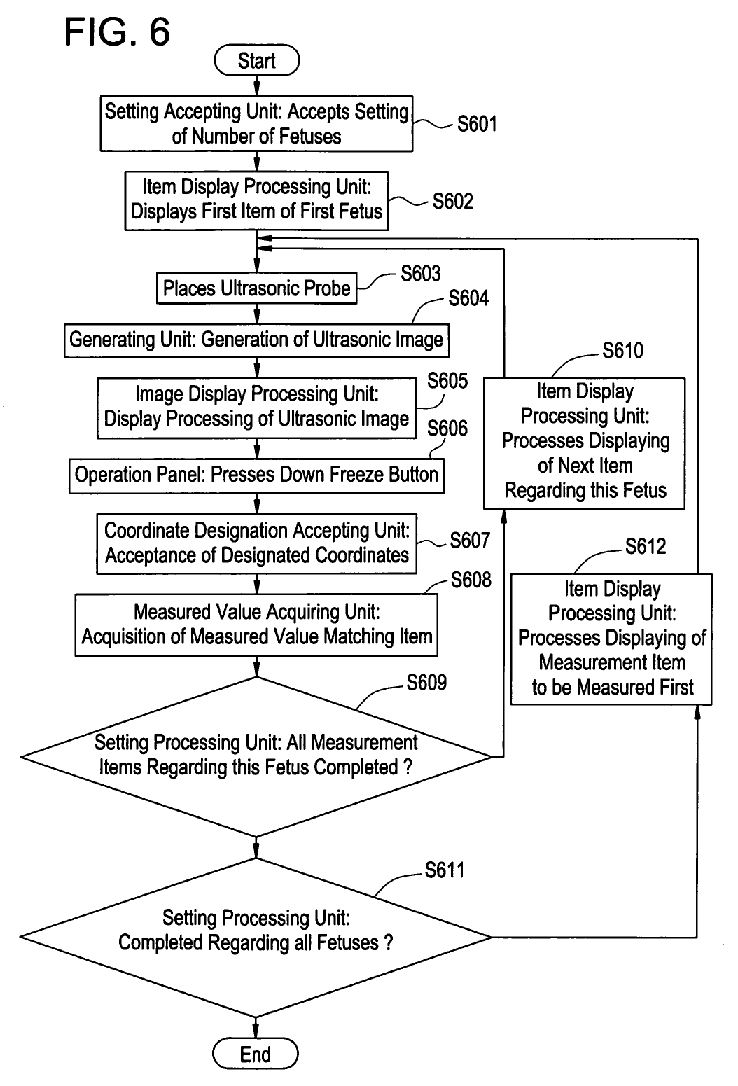

FIG. 6 is a flow chart showing the procedure of processing on an item-by-item basis as described from the time the setting of the number of fetuses is accepted until measured values are acquired of all the items regarding multiple fetuses in the ultrasound diagnostic apparatus in the mode for implementing the invention.

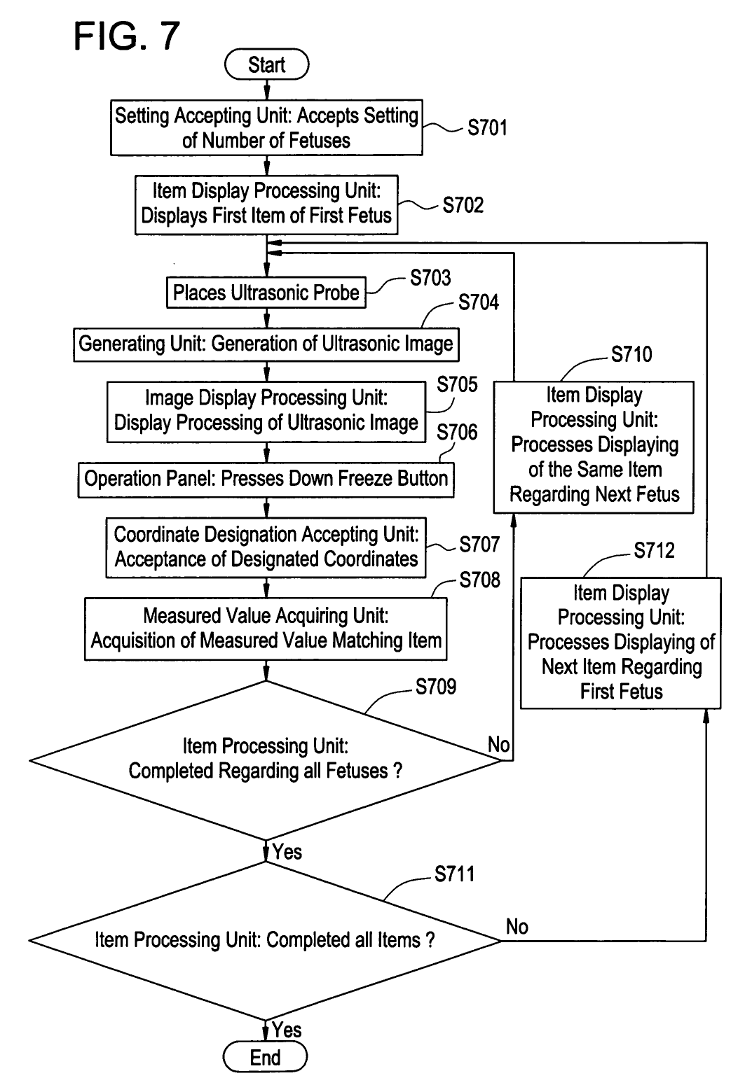

FIG. 7 is a flow chart showing the procedure of processing on a fetus-by-fetus basis as described from the time the setting of the number of fetuses is accepted until measured values are acquired of all the items regarding multiple fetuses in the ultrasound diagnostic apparatus in the mode for implementing the invention.

### DETAILED DESCRIPTION OF THE INVENTION

An ultrasound diagnostic apparatus, an ultrasound diagnostic method and an ultrasound diagnostic program pertaining to the present invention in the best mode for implementation will be described in detail with reference to the accompanying drawings. Incidentally, this embodiment is nothing to limit the invention.

FIG. 1 is a perspective view schematically showing an ultrasound diagnostic apparatus 100 in this mode for implementation. As shown in FIG. 1, the ultrasound diagnostic apparatus 100 is provided with an ultrasonic probe 1 which transmits an ultrasonic pulse into a subject (the body of a patient) and receives an ultrasonic echo from within the subject, an ultrasound diagnostic apparatus body 2 which generates an ultrasonic image on the basis of the ultrasonic echo, and a monitor 3 which displays the ultrasonic image.

The ultrasound diagnostic apparatus body 2 is provided with an operation panel 4 which accepts the operator's instructions and a storage device 5 which is the main storage device for storing ultrasonic images and measured values of each prescribed measurement item, measured from the ultrasonic images. The storage device 5 is, for instance, an HDD (hard disk drive).

Specific image pickup conditions include, for example, the type of the ultrasonic probe 1 used for image pickup (e.g. linear electron scanning, sector electron scanning, mechanical electron scanning or convex electron scanning), the frequency of the ultrasonic pulse, the dynamic range defining the range of received echo intensity, the gain defining the relative amplification of received echo intensity, the velocity scale range defining the range of spectral display according to the velocity of blood flow, the gray map used as the conversion map for displaying received echo signals in different shades of gray, the color map for use as the conversion map for color displaying, the color area position defining the position of the interest area cursor for color Doppler signal detection, the sample volume position defining the detecting position for acquiring Doppler blood current signals, and the time scale range defining the time width per unit pixel.

On the operation panel 4, there are arranged an image list button BM for instructing the displaying of an image list (not shown) of previously obtained ultrasonic images, a record button B1 with image pickup conditions for instructing the storing of ultrasonic images with image pickup conditions, an image pickup condition recall button B2 for reading and setting the image pickup conditions contained in image-related file F1 with image pickup conditions, an enlarged display button BR for instructing enlarged displaying of an ultrasonic image, a freeze button BF for instructing the displaying of an ultrasonic image in a frozen state, a determination button BL for determining the number of fetuses or positional coordinates specified by a cursor or the like, and a track ball TR for moving the position of the cursor or the like for use when setting the number of fetuses or setting a positional coordinate matching each measurement item.

FIG. 2 is a configurational diagram showing the hardware configuration of each unit and functional block built into the ultrasound diagnostic apparatus 100 in this mode for implementation. This ultrasound diagnostic apparatus 100 is configured to be equipped with an ultrasonic probe 1, a transceiver circuit 11, a signal processing circuit 12, an A/D converter 13, an arithmetic unit 17, an RGB conversion processing circuit 14, a D/A converter 15, a video signal processing circuit 16, the monitor 3, the operation panel 4 and the storage device 5.

In this ultrasound diagnostic apparatus 100, ultrasonic echo signals e at a plurality of two-dimensionally distributed sampling points of the subject are collected by the ultrasonic probe 1 and the transceiver circuit 11. Next, signals S1 for B/W and signals S2 for CFM are generated from the ultrasonic echo signals e by the signal processing circuit 12. Then, signals resulting from conversion of these generated signals by the A/D converter 13 are inputted to the arithmetic unit 17. And, as the arithmetic unit 17 generates an ultrasonic image, and the measured value of each prescribed measurement item of each fetus is acquired on the basis of the generated ultrasonic image. On the other hand, when the ultrasonic image generated by the arithmetic unit 17 is processed for displaying, image signals are outputted, and RGB data R, G and B are generated by the RGB conversion processing circuit 14 from the inputted image signals. Next, the RGB data R, G and B are converted into video signals by the D/A converter 15 and the video signal processing circuit 16. And an ultrasonic image is displayed by the monitor 3. On the other hand, the number of fetuses and other information inputted from the operation panel 4 are inputted to the arithmetic unit 17. Also, the measured value of each prescribed measurement item or the ultrasonic image is saved from the arithmetic unit 17 into the storage device 5.

The arithmetic unit 17 shown in FIG. 2, equipped with a generating unit 101, a display processing unit 102, a setting accepting unit 103, a measured value acquiring unit 104, a coordinate designation accepting unit 105, a saving unit 108 and a setting processing unit 109, generates ultrasonic images on the basis of inputted signals and acquires a measured value of measurement item from ultrasonic images.

An example of actual hardware of the arithmetic unit 17 may conceivably comprise a CPU (central processing unit) which performs processing, a ROM (read only memory) in which a program of the above-described configuration is stored dedicated to reading, and a RAM (random access memory) 12 which can be used as a working area and rewritably stores various data, all connected by a bus. A DSC for performing format conversion of image data into a screen format may also included to enable an image display processing unit 106, to be described afterwards, provided in the display processing unit 102 to process displaying of ultrasonic images.

The generating unit 101 generates ultrasonic images on the basis of inputted signals. The generation of ultrasonic images on the basis of inputted signals may use known techniques, and ultrasonic images may be generated by using any technique.

The display processing unit 102, equipped with the image display processing unit 106 and an item display processing unit 107, processes displaying on the monitor by generating image signals and outputting them to the RGB conversion processing circuit 14.

The image display processing unit 106 processes ultrasonic image displaying by generating and outputting as image signal the ultrasonic images generated by the generating unit 101. The image display processing unit 106 outputs in a real time state image signals of ultrasonic images generated by the generating unit 101. And when the freeze button BF of the operation panel 4 has been pressed down, the image display processing unit 106 outputs image signals of the still ultrasonic image at the time the freeze button BF has been pressed down. Then the measured value acquiring unit 104, to be described afterwards, acquires the measured value of each measurement item from the still ultrasonic image.

The item display processing unit 107 performs display processing by sequentially outputting image signals prescribed measurement items to be measured of fetuses as many times as the number of fetuses set by the setting accepting unit 103 to be described afterwards. In other words, where a plurality of fetuses is in the same mother's body, the plurality of measurement items should be applied to every fetus. For this reason, the item display processing unit 107 performs processing to display each measurement item for every fetus. Incidentally, a detailed sequence of display processing will be described afterwards. To add, the prescribed measurement items are supposed in this mode for implementation to be measurement items selected by the use with the setting accepting unit 103 to be described afterwards, but they need not be limited to selected measurement items but may as well be measurement items held in advance by the ultrasound diagnostic apparatus 100.

Further, in measuring multiple fetuses with the ultrasound diagnostic apparatus 100 in this mode for implementation, the number of fetuses should be set in advance. For this reason, the item display processing unit 107 processes displaying of a screen to set the number of fetuses.

FIG. 3 shows an example of measurement object setting screen to be displayed on the monitor 3 before measuring fetuses. As shown in this drawing, it is necessary to set an ID, a name and the number of fetuses before measuring. The ID is a patient ID which distinguishes the mother's body to be examined from any other mother's body. This enables measured values, when they are to be saved in the storage device 5, to be distinguished from measured values taken from any other mother's body. The name is the name of the mother's body. And the number of fetuses is selected from 1 through 4, which are displayed. This enables the item display processing unit 107 to process displaying of measurement items for each of as many fetuses as the selected number of fetuses. Furthermore, when storing into the storage device 5 is to be done, it is made possible to save as many measured values of each measurement item for the selected number of fetuses.

Further on the screen shown in this drawing, the item display processing unit 107 process displaying of an “item setting” button 301. When this “item setting” button 301 is pressed down, the item display processing unit 107 processes displaying a screen for altering the setting of items to enable the setting for use in measuring to be altered.

FIG. 4 is a diagram showing an example of setting change screen of items displayed when the “item setting” button has been pressed down. As shown in this diagram, displaying of the measurement items to be measured and the measuring sequence is processed, and the setting accepting unit 103 to be described afterwards accepts the selection of measurement items or an altered measuring sequence.

As shown in this diagram, the settable measurement items in this mode for implementation comprise item I through item n. To state these measurement items in specific terms, for instance BPD (biparietal diameter) is conceivable for item 1, FL (femur length) for item 2, and SAC (gestational sac size) for item 3. To add, the settable measurement items are not limited to the above-cited examples, but may include any measurement item pertinent to fetuses.

Referring back to FIG. 2, the setting accepting unit 103 accepts the setting of the number of fetuses and the like inputted from the operation panel 4 when the measurement object setting screen or the setting change screen for items is displayed. More specifically, the setting accepting unit 103, when the measurement object setting screen is displayed, accepts the setting of the patient ID or name or the number of fetuses. In other words, when the patient ID is to be registered first, the setting accepting unit 103 accepts the setting of the name and the number of fetuses together with the patient ID. When the input of a patient ID is accepted after that, the number of fetuses matching the first inputted patient ID is set, and the measuring of the mother's body identified by the patient ID is started.

Also the setting accepting unit 103, when the setting change screen for items is displayed, accepts the selection of measurement items or the setting of the sequence of measuring to be done. The selection of measurement items means that, when the physician wants to alter any measurement item regarding a fetus, the setting accepting unit 103 accepts the altered measurement item from the setting change screen for items. This causes the item display processing unit 107 to process displaying according to the altered measurement item from the next time onward. As this enables the physician to alter measurement items from fetus to fetus as required, the convenience is enhanced.

Further, the setting accepting unit 103 accepts the choice of the sequence of measuring whether to perform measuring fetus by fetus or item by item. And the item display processing unit 107 will successively display the information to be displayed according to the measuring sequence accepted by the setting accepting unit 103. Incidentally, the processing procedure for each measuring sequence will be described afterwards.

The setting processing unit 109 so performs control that the item display processing unit 107 may process displaying of measurement items according to the number of fetuses or the processing procedure accepted by the setting accepting unit 103. More specifically, the setting processing unit 109 judges whether or not measuring of the selected measurement item has been completed or measuring of the set number of fetuses has been completed and, if it judges that it has not been completed, so performs control that the item display processing unit 107 may display the next measurement item.

The coordinate designation accepting unit 105 accepts coordinate information designated with the track ball TR and the determination button BL on the operation panel 4 regarding the ultrasonic image displayed on the monitor 3 by the image display processing unit 106. By accepting coordinate information regarding the displayed ultrasonic image, the coordinate area or distance information matching the measurement items on the monitor 3 is specified.

The measured value acquiring unit 104, taking into account the scale reduction or the like of the image displayed on the monitor 3, acquires the measured value matching the measurement item from the coordinate area or distance information on the monitor 3 accepted by the coordinate designation accepting unit 105. Incidentally, the method of acquiring this measured value may be any method, no matter whether it is well known or not. And the measured value will be displayed by the item display processing unit 107 in the item position.

FIGS. 5a, 5b, and 5c are explanatory diagrams showing the sequence from the acceptance of designation of coordinate information from the ultrasonic image displayed for each measurement item of each fetus until the displaying of the measured value. In these diagrams, the number of fetuses is supposed to be two and the selected measurement items, only item 1 and item 2. And the selected measuring sequence is supposed to be fetus by fetus.

As shown in FIGS. 5a, 5b, and 5c, the item display processing unit 107 processes displaying of “A, item 1” in item blank 501 of the screen shown in FIG. 5a. As this enables the physician first to measure item 1 with respect to fetus A, he/she would place the ultrasonic probe 1 at a position where item 1 of fetus A can be measured. And processing by the ultrasound diagnostic apparatus 100 takes place, and an ultrasonic image is displayed on the monitor 3. If it is judged that item 1 of fetus A can be measured from this ultrasonic image, the physician will press down the freeze button BF. As this causes the ultrasonic image to stand still, he/she will designate with the track ball TR and the determination button BL coordinate information matching item 1. In the example shown in FIG. 5a, the physician would indicate x marks at both ends of the dotted line. This enables distance information matching item 1 to be identified. And the measured value acquiring unit 104 acquires the measured value of item 1 from this distance information, and finally the item display processing unit 107 processes displaying of this measured value in item blank 501. If there is no input from the operation panel 4 within a prescribed length of time after this, the item display processing unit 107 will process displaying of the next item to be measured. Although this prescribed length of time is supposed to be five seconds in this mode for implementation, this is nothing to limit the prescribed length of time. Also, the processing by the item display processing unit 107 to display the next item may as well be required to take place only when an input is received from the operation panel 4, such as pressing-down of the determination button BL by the user.

Next, the item display processing unit 107 processes displaying of “B, item 1” in item blank 502. This enables the physician to recognize that item 1 of fetus B is to be measured next. And he/she would proceed in the same procedure as described above until the displaying of the acquired measured value in item blank 502 is processed shown in FIG. 5b.

Then, the item display processing unit 107 processes displaying of “A, item 2” in item blank 503 shown in FIG. 5c. This enables the physician to understand that item 2 can be measured of fetus A. And he/she would proceed in the same procedure as described above until the displaying of the acquired measured value in item blank 503. As the physician proceeds in the measurement of a plurality of measurement items regarding a plurality of fetuses according to the measurement items whose displaying has been processed by the item display processing unit 107 in this way, there is no need to designate the fetus and the item at the time of measuring. In other words, the physician is prevented from forgetting in the measuring process the measuring any fetus among the plurality of fetuses.

Referring back to FIG. 2, the saving unit 108 saves in the storage device 5 measured values associated with patient IDs. Further, when the record button B1 has been pressed down, the saving unit 108 saves in the storage device 5 an ultrasonic image with image pickup conditions. By saving values measured of fetuses, it is made possible to compare them with previous measured values, and to keep track of the growth process of each one of multiple fetuses.

Next, the processing in the ultrasound diagnostic apparatus 100 in this mode for implementation configured as described from the time the setting of the number of fetuses is accepted until measured values are acquired of all the items regarding multiple fetuses will be described below. FIG. 6 is a flow chart showing the procedure of the above-described processing in the ultrasound diagnostic apparatus 100. To add, the flow chart shown in this diagram supposes that the measuring sequence is according to items, and the displaying of a measurement item and the acquisition of a measured value are performed sequentially regarding each fetus, and this is repeated as many times as the aforementioned set number of fetuses.

First, the setting accepting unit 103 accepts setting of the number of fetuses from the measurement object setting screen (step S601). On this occasion, setting of the patient ID and the like is also accepted as stated above. Or, if the number of fetuses is already set by previous measuring or otherwise, the acceptance of setting of the number of fetuses at step S601 will be dispensed with.

Next, the item display processing unit 107 processes displaying of the first item to be measured of the first fetus on the monitor 3 (step S602).

And the physician places the ultrasonic probe 1 against the mother's body to measure the item of the fetus displayed by the item display processing unit 107 (step S603).

Next, the generating unit 101 generates an ultrasonic image from signals inputted from the ultrasonic probe 1 (step S604). And the image display processing unit 106 processes displaying of the generated ultrasonic image on the monitor 3 (step S605).

And the physician confirms the ultrasonic image having undergone display processing and, if he/she judges that the item of the fetus displayed by the item display processing unit 107 can be measured, will press down the freeze button BF (step S606). The image display processing unit 106 performs processes displaying in a still state the ultrasonic image which has been in a real time state.

Next, the coordinate designation accepting unit 105 accepts the designation of coordinate information inputted by the user with the track ball TR and the determination button BL according to the ultrasonic image displayed on the monitor 3 (step S607). This enables the coordinate area or distance information on the monitor 3 matching the item to be identified.

And the measured value acquiring unit 104 acquires the measured value matching the measurement item from the coordinate area or distance information on the monitor 3 according to the coordinate information accepted by the coordinate designation accepting unit 105 (step S608).

Next, the setting processing unit 109 judges whether or not the acquisition of measured values of all the measurement items regarding this fetus has been completed (step S609). And if it is judged that the acquisition of measured values of all the measurement items has not been completed (step S609: No), the item display processing unit 107 will process displaying of the next measurement item regarding this fetus (step S610). After this, the sequence is restarted from the placement of the ultrasonic probe 1 by the physician (step S603).

Or if the setting processing unit 109 judges that the acquisition of measured values of all the measurement items regarding this fetus has been completed (step S609: Yes), the setting processing unit 109 will judge whether or not measuring has been completed regarding all the fetuses (step S611).

And if the setting processing unit 109 judges that measuring has not been completed regarding all the fetuses (step S611: No), the item display processing unit 107 will process displaying of the measurement item to be measured first (step S612). After this, the sequence is restarted from the placement of the ultrasonic probe 1 by the physician (step S603).

Or if the setting processing unit 109 judges that measuring has been completed regarding all the fetuses (step S611: Yes), the sequence is completed as all the measurement items regarding all the fetuses have been measured.

Merely by performing measuring in accordance with the displayed measurement items in the procedure of processing described above, it is possible to measure all the measurement items regarding all the fetuses. To add, the procedure of processing described above is an example of procedure of processing from the acceptance of the setting of the number of fetuses until the acquisition of item-by-item measured values regarding a plurality of fetuses in this mode for implementation, but this is nothing to limit the present invention to this procedure of processing. As the procedure of processing described above referred to an item-by-item measuring sequence, a fetus-by-fetus case will be described below.

Processing from the acceptance of setting of the number of fetuses until the acquisition of measured values of all the items regarding a plurality of fetuses in the ultrasound diagnostic apparatus 100 in this mode for implementation configured as stated above will be described. FIG. 6 is a flow chart showing the procedure of the above-stated processing in the ultrasound diagnostic apparatus 100 in this mode for implementation. Incidentally, the flow chart shown in this diagram supposes that the measuring sequence is according to fetuses, and the displaying of a measurement item and the acquisition of a measured value are performed sequentially regarding each fetus, and this is repeated as many times as the aforementioned selected number of measurement items.

First, in the same way as at step S601 and step S602 in FIG. 6 described above, after the acceptance of setting of the number of fetuses, displaying of the first measurement item regarding the first fetus is processed (step S701 through step S702).

Next, in the same way as at step S603 through step S608 in FIG. 6, after placing the ultrasonic probe 1, steps until the acquisition of the measured value matching the measurement item are taken (step S703 through step S708).

Next, the setting processing unit 109 judges whether or not the measured value of this measurement item has been acquired from all the fetuses (step S709). And if it is judged that the measured value has not been acquired from all the fetuses (step S709: No), the item display processing unit 107 will process displaying of this measurement item regarding the next fetus (step S710). After this, the sequence is restarted from the placement of the ultrasonic probe 1 by the physician (step S703).

Or if the setting processing unit 109 judges that the acquisition of measured values of this measurement item regarding all the fetuses has been completed (step S709: Yes), the setting processing unit 109 will judge whether or not measuring has been completed of all the measurement items (step S711).

And if the setting processing unit 109 judges that measuring has not been completed of all the measurement items (step S711: No), the item display processing unit 107 will process displaying of the next measurement item regarding the first fetus (step S712). After this, the sequence is restarted from the placement of the ultrasonic probe 1 by the physician (step S703).

Or if the setting processing unit 109 judges that measuring has been completed of all the measurement items (step S711: Yes), the sequence is completed as all the measurement items regarding all the fetuses have been measured.

Merely by performing measuring in accordance with the displayed measurement items in the procedure of processing described above, it is possible to measure all the measurement items regarding all the fetuses. To add, the procedure of processing described above is an example of procedure of processing from the acceptance of the setting of the number of fetuses until the acquisition of item-by-item measured values regarding a plurality of fetuses in this mode for implementation, but this is nothing to limit the present invention to this procedure of processing.

To add, although this mode for implementation has been described with reference to a case in which multiple fetuses are measured of each measurement item with an ultrasound diagnostic apparatus, the mode is not limited to this, but, where it is required to measure a plurality of measurement items regarding each of a plurality of subjects, the physician is enabled to measure all the measurement items without having to do setting by setting the number of subjects and using the above-described procedure of processing.

Or in the presence of a plurality of subjects for an ultrasound diagnostic apparatus where there are a plurality of measurement items as in the case of multiple fetuses, similar application is possible.

Although an Ultrasound diagnostic program to be executed by the ultrasound diagnostic apparatus in this mode for implementation is supposed to be built into a ROM or the like contained in the arithmetic unit, the possible configuration is not limited to this.

For instance, a configuration is also conceivable in which the Ultrasound diagnostic program to be executed by the ultrasound diagnostic apparatus in this mode for implementation is provided in a file of an installable form or an executable form, recorded on a computer-readable recording medium such as a CD-ROM, a flexible disk (FD), CD-R or a DVD (digital versatile disk).

Further, a configuration is also conceivable in which the Ultrasound diagnostic program to be executed by the ultrasound diagnostic apparatus in this mode for implementation is stored on a computer connected to a network, such as the Internet, to be downloaded via the network. The Ultrasound diagnostic program to be executed by the ultrasound diagnostic apparatus in this mode for implementation may as well be so configured as to be provided or distributed via a network, such as the Internet.

The Ultrasound diagnostic program to be executed by the ultrasound diagnostic apparatus in this mode for implementation is in a modular configuration comprising the above-described units (generating unit, display processing unit, setting accepting unit, measured value acquiring unit, coordinate designation accepting unit, saving unit and setting processing unit), and in actual hardware the above-mentioned units are loaded onto a main storage device as the CPU reads out of the ROM and executes the Ultrasound diagnostic program, with the result that the generating unit, display processing unit, setting accepting unit, measured value acquiring unit, coordinate designation accepting unit, saving unit and setting processing unit are generated on the main storage device.

Many widely different embodiments of the invention may be configured without departing from the spirit and the scope of the present invention. It should be understood that the present invention is not limited to the specific embodiments described in the specification, except as defined in the appended claims.

1. An ultrasound diagnostic apparatus comprising:
a setting accepting device which accepts setting of the number of fetuses indicating the number of fetuses in the same mother's body;
an item display processing device which, regarding each of said fetuses of said number of fetuses set by said setting accepting device, processes sequential displaying of the measurement item to be measured next according to said fetuses and the measurement item which needs to be measured;
a generating device which receives a reflected wave from an ultrasonic wave transmitted from an ultrasonic probe every time said measurement item is displayed by said item display processing device, and generates an ultrasonic diagnostic image matching said measurement item according to the reflected wave;
an image display processing device which processes displaying of said ultrasonic diagnostic image generated by said generating device; and
a measured value acquiring device which, according to said ultrasonic diagnostic image displayed by said image display processing device, acquires the measured value of said fetus with respect to said measurement item displayed by said item display processing device.

2. The ultrasound diagnostic apparatus according to claim 1, wherein said item display processing device repeatedly performs sequential displaying of said measurement items which need to be measured for one of said fetuses as many times as said number of fetuses set by said setting accepting device.

3. The ultrasound diagnostic apparatus according to claim 1, wherein said item display processing device repeats processing of sequential displaying of one kind of said measurement item for each of said fetuses of said number of fetuses set by said setting accepting device as many times as the number of said measurement items which need to be measured.

4. The ultrasound diagnostic apparatus according to claim 1, further comprising a saving device which saves measured values regarding said measurement items for each of said fetuses measured by said measured value acquiring device.

5. The ultrasound diagnostic apparatus according to claim 1 or claim 4, wherein said setting accepting device further accepts selection by the user of said measurement item to be measured of said fetus.

6. An ultrasound diagnostic apparatus comprising:
a setting accepting device which accepts setting of the number of subjects which are to be the objects of measuring;
an item display processing device which, regarding each subject of said number of subjects set by said setting accepting device, processes sequential displaying of the measurement item to be measured next according to said subject and the measurement item which needs to be measured;
a generating device which receives a reflected wave from an ultrasonic wave transmitted from an ultrasonic probe every time said measurement item is displayed by said item display processing device, and generates an ultrasonic diagnostic image matching said measurement item according to the reflected wave;
an image display processing device which processes displaying of said ultrasonic diagnostic image generated by said generating device; and
a measured value acquiring device which, according to said ultrasonic diagnostic image displayed by said image display processing device, acquires the measured value of said subject with respect to said measurement item displayed by said item display processing device.

7. An Ultrasound diagnostic method comprising:
a setting accepting step at which setting of the number of fetuses indicating the number of fetuses in the same mother's body is accepted;
an item display processing step at which, regarding each of said fetuses of said number of fetuses set at said setting accepting step, sequential displaying of the measurement item to be measured next is processed according to said fetuses and the measurement item which needs to be measured;
a generating step at which a reflected wave is received from an ultrasonic wave transmitted from an ultrasonic probe every time said measurement item is displayed at said item display processing step, and an ultrasonic diagnostic image matching said measurement item is generated according to the reflected wave;
an image display processing step at which displaying of said ultrasonic diagnostic image generated at said generating step is processed; and
a measured value acquiring step at which, according to said ultrasonic diagnostic image displayed at said image display processing step, the measured value of said fetus with respect to said measurement item displayed by said item display processing step is acquired.

8. The Ultrasound diagnostic method according to claim 7, wherein at said item display processing step, sequential displaying of said measurement items which need to be measured is repeatedly performed for one of said fetuses as many times as said number of fetuses set at said setting accepting step.

9. The Ultrasound diagnostic method according to claim 7, wherein at said item display processing step, processing of sequential displaying of one kind of said measurement item for each of said fetuses of said number of fetuses set at said setting accepting step is repeated as many times as the number of said measurement items which need to be measured.

10. The Ultrasound diagnostic method according to claim 7, further comprising a saving step at which measured values regarding said measurement items are saved for each of said fetuses measured at said measured value acquiring step.

11. The Ultrasound diagnostic method according to claim 7, wherein at said setting accepting step selection by the user of said measurement item to be measured of said fetus is further accepted.
